(19) United States
(12) Patent Application Publication
(10) Pub. No.: US 2010/0037299 A1
(43) Pub. Date: Feb. 11, 2010

(54) Method, System, And Computer Program Product For Identifying An Authorized Officer Of A Business

(75) Inventors: Zev W. Karasick, Kew Gardens, NY (US); Atul K. Srivastava, Edison, NJ (US); Michael A. Vapenik, Berkeley Heights, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 12/188,552

(22) Filed: Aug. 8, 2008

(51) Int. Cl. G06F 7/58

(52) U.S. Cl. 726/4

(57) ABSTRACT

A method, system, and computer program product are used to identify an authorized officer of a business. In accordance with an exemplary method, titles of executives associated with the business are received from a plurality of data sources. Each executive's title may be classified as authorized, non-authorized or undecided, and each executive's title classified as undecided may be further classified as authorized or non-authorized by using information on the business. For each executive, conformance across the data sources of the executive's title classification is assessed, and each executive is classified as being an authorized officer, a non-authorized officer or a potential authorized officer based on the title classification and the assessed conformance. A measure of confidence is associated with each executive classification.

### BACKGROUND OF THE INVENTION

1. Field of the Invention

The present invention generally relates to marketing and delivery of goods and services, and more particularly to systems and methods for identifying decision-makers within a business.

2. Related Art

Direct marketing has become one of the major marketing channels used today.

Depending on the product or the service being marketed, it may be desirable to market to a particular group of consumers who are considered to be more likely interested in the product or service than the world of consumers generally. Where the consumer is a business, it may be desirable to market to one or more key executives of the business, since the key executives may be the individuals who have the authority to obtain the product or service for the business. For example, with a product or service involving credit cards, or other financial transaction instruments, which are designed for business owners and decision-makers to use for business related spending needs, it may be desirable to target the key executive of a business from the entire employee population for receipt of marketing materials concerning financial transaction instruments designed for the business. By directly targeting such marketing materials to the key executives, there may exist a greater likelihood the materials will indeed reach the key executive, whereby the executive can then seek to obtain the marketed product or service.

Typically a solicitation to a business is generically addressed to the business, without reference to any associated individual. Offers for the product or service may be sent to the prospect business as a generic mail piece, addressed, for example, to “Dear Business Owner”. In order to respond to such generic mail piece, the recipient at the business must (a) open a generic mail piece, and (b) forward to the appropriate executive to review and decide to accept. For transaction cards designed for small businesses in particular, in which account liability for a transaction card is shared between the business and the individual executive applicant, it is imperative that a key executive is solicited to apply for such a transaction card. With a generic mail piece, such solicitation may not reach the intended target. The solicitation may also be returned by the post office for lack of contact name on the generic mail piece. Consequently, response rates with generic solicitations may under perform. Further, an individual responding for the business may not be a key executive and the financial transaction card may still be extended to him or her, resulting in risk exposure for the provider of the financial transaction card. During a suppression process to determine targeted businesses to receive such marketing materials, an inability to identify one or more key executives of a business may result in excluding the business from solicitation, because a known employee is an existing cardmember of the provider or has poor credit quality, regardless of whether or not such employee is in fact a key executive. As a result, a valid business prospect is lost in the suppression process, as the key executive may be neither an existing cardmember nor of poor credit quality.

While individuals source vendors (e.g., Dunn & Bradstreet of Short Hills, N.J., Donnelley Marketing of Marshfield, Wis., Experian of Costa Mesa, Calif., Equifax of Atlanta, Ga., Mal Dunn Associates, Inc. of Brewster, N.Y., etc.) may provide executive designation information for businesses, such executive designation information standing alone often does not correctly identify the actual authorized officers (i.e., key executives and decision makers) within the business executive population of a business. Such vendors may have collected the executive designation information from a variety of primary sources (e.g., questionnaires, magazine subscriptions, etc.), and may have standardized raw input titles into normalized values, but it can often be difficult to assess the level of decision-making responsibility of an executive from the title alone (e.g., “Manager”). Further, one source vendor may identify a given executive as a “Manager” when another source vendor may provide a title of “President” for the same individual of the business. Therefore while individual sources may provide designation information on executives of businesses, varied levels of coverage and titles standardization exist across the sources. As a result it is difficult to determine the actual authorized officers within the executive business population.

What is needed therefore is a method, system, and computer program product for identifying such key executives of a business.

### SUMMARY OF THE INVENTION

Embodiments of the present invention meet the above identified needs by providing a method, system, and computer program product for identifying authorized officers of businesses. Embodiments of the invention employ a series of processing steps to standardize, consolidate, rate, and collapse varied source data on these executives into a final authorized officer identification recommendation. The recommendations may also be assigned a confidence code corresponding to the number of contributing sources and quality of conformance across those sources.

A computer based method for identifying an authorized officer of a business is presented. In accordance with one embodiment, steps of the method include receiving, from a plurality of data sources, titles of executives associated with the business; classifying each title as authorized or non-authorized; for each executive, assessing conformance across the data sources of the executive's title classification; classifying each executive as being an authorized officer, a non-authorized officer or a potential authorized officer based on the title classification and the assessed conformance; associating a measure of confidence with each executive classification; identifying as an authorized officer of the business each executive classified as an authorized officer with a measure of confidence that is above a predetermined threshold value; and storing in a database identifying information for identified authorized officers.

In accordance with another embodiment, steps of the method include receiving, from a plurality of data sources, information on at least one executive associated with the business; associating, for each data source, an authorized officer (AO) indicator for each executive; associating a measure of confidence with each AO indicator; and storing in a database identifying information of the executive, the executive's AO indicator and associated measure of confidence for each data source.

A computer program product for identifying an authorized officer of a business generating is also presented and includes a computer useable medium having a computer program logic recorded thereon for controlling at least one processor. The computer program logic includes computer program code configured to implement embodiments of the methods presented herein. A system is also presented which is configured to implement embodiments of the methods presented herein.

One advantage of some embodiments of the present invention is that they may be used to provide personalized offers of products or services to prospects and existing customers that are more effective, financially profitable, and brand enhancing. A soliciting company may personalize their solicitations and directly address the key executives at a prospect business, thus minimizing the population of returned solicitation mail and increasing response rates. Another advantage of some embodiments of the present invention is that they may be used to determine which businesses receive solicitation (e.g., in the suppression decisioning). Where a financial transaction card is being offered to a business, embodiments of the present invention may be used as part of the underwriting decision to improve the discriminating power of the credit risk associated with the particular executive applicant, whereby credit losses may be reduced. Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a high level flow diagram of a process for identifying an authorized officer of a business in accordance with an embodiment of the present invention.

FIG. 2 is a chart showing an exemplary title standardization step in the method of FIG. 1, illustrating representative examples of raw titles of executives and their associated normalized titles.

FIG. 3A is a detailed high level flow diagram showing an exemplary title classification step in the method of FIG. 1.

FIG. 3B is chart showing categorization of representative raw titles of executives of a business into AO titles, undecided titles, and non-AO titles, in accordance with one embodiment of the present invention.

FIG. 4 is a detailed high level flow diagram showing an exemplary step of overall AO classification in the method of FIG. 1.

FIG. 5 is a chart of overall AO classification and associated confidence code, in accordance with one embodiment of the present invention.

FIG. 6 is a detailed high level flow diagram showing processes associated with the step of overall AO classification shown in FIG. 4, in accordance with one embodiment of the present invention.

FIG. 7 is a high level flow diagram showing an exemplary assessment of whether identified authorized officers obtained from the method of FIG. 1 correspond with a financial institution's existing business card members.

FIG. 8 is a chart of title classifications and overall authorized officer classifications for an example business on which the method of FIG. 1 was applied.

FIG. 9 is a chart of title classifications and overall authorized officer classifications for another example business on which the method of FIG. 1 was applied.

FIG. 10 is a block diagram of an exemplary computer system useful for implementing the present invention.

### DETAILED DESCRIPTION

### I. Overview

A method, system, and computer program product are described for identifying an authorized officer of a business, whereby a database of decision-makers within businesses may be populated. Embodiments of the present invention are now described in more detail herein in terms of the above exemplary description. This is for convenience only and is not intended to limit the application of the present invention. In fact, after reading the following description, it will be apparent to one skilled in the relevant art(s) how to implement the following invention in alternative embodiments.

Furthermore, the terms “business” or “merchant” may be used interchangeably with each other and shall mean any person or entity (including partnerships, corporations, and profit or non-profit organizations) that is a provider, broker and/or any other entity in the distribution chain of goods or services. For example, a business may be a grocery store, a retail store, a travel agency, a service provider, a manufacturer or the like.

Financial transaction instruments may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

Furthermore, the term “small business cards” (as referred to herein simply as SB cards) refers to open cards designed for business owners and decision makers (and their employees) to use for business-related spending needs. SB cards are designed for small businesses in particular, with account liability for an SB card being shared between the business and the individual executive applicant. The individual executive applicants of SB cards are referred to herein as “Basics”.

### I. Process

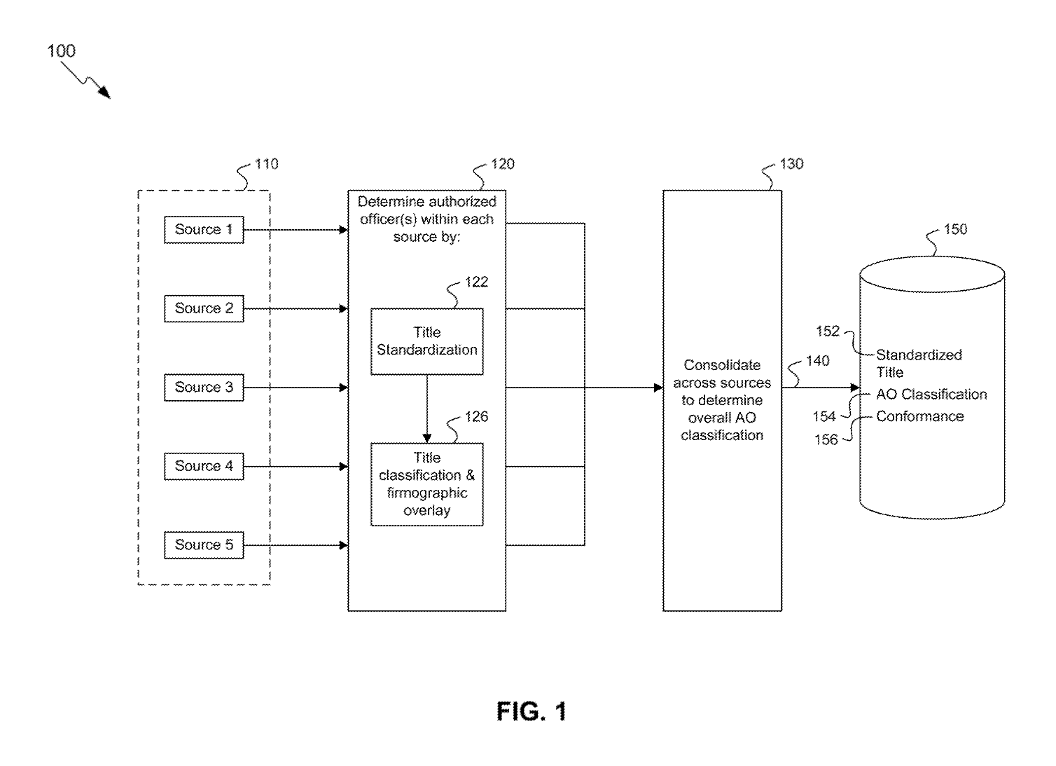

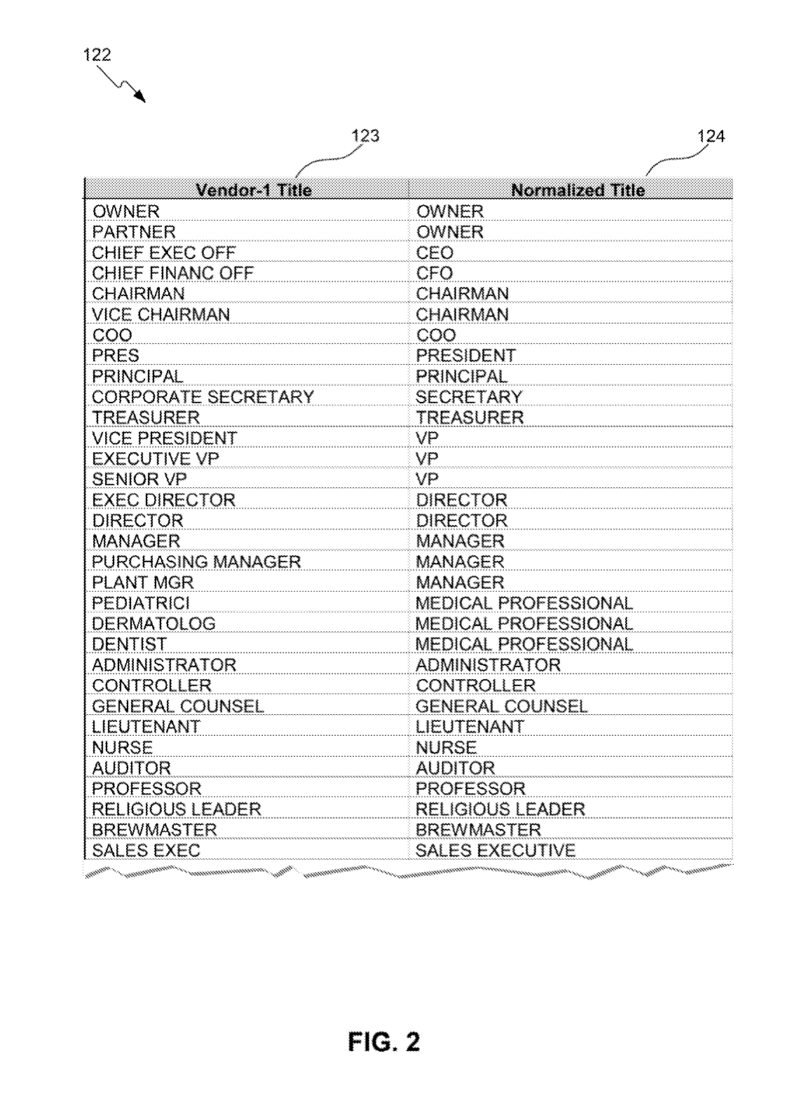

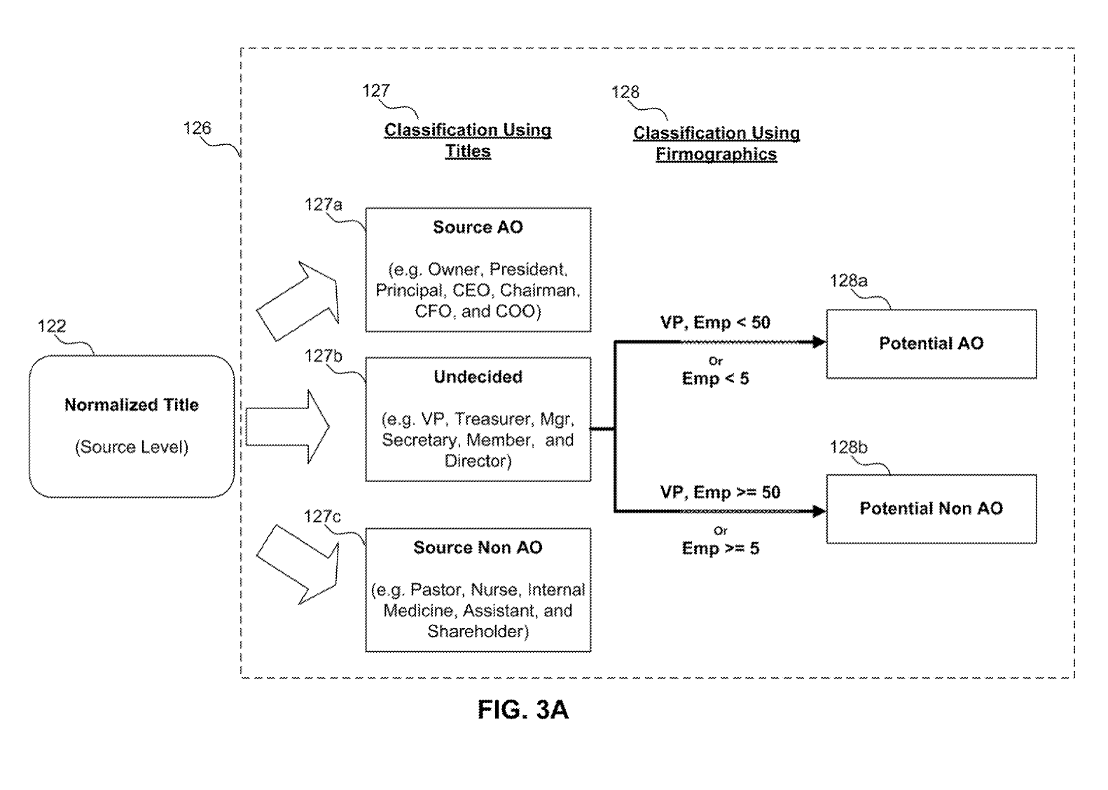

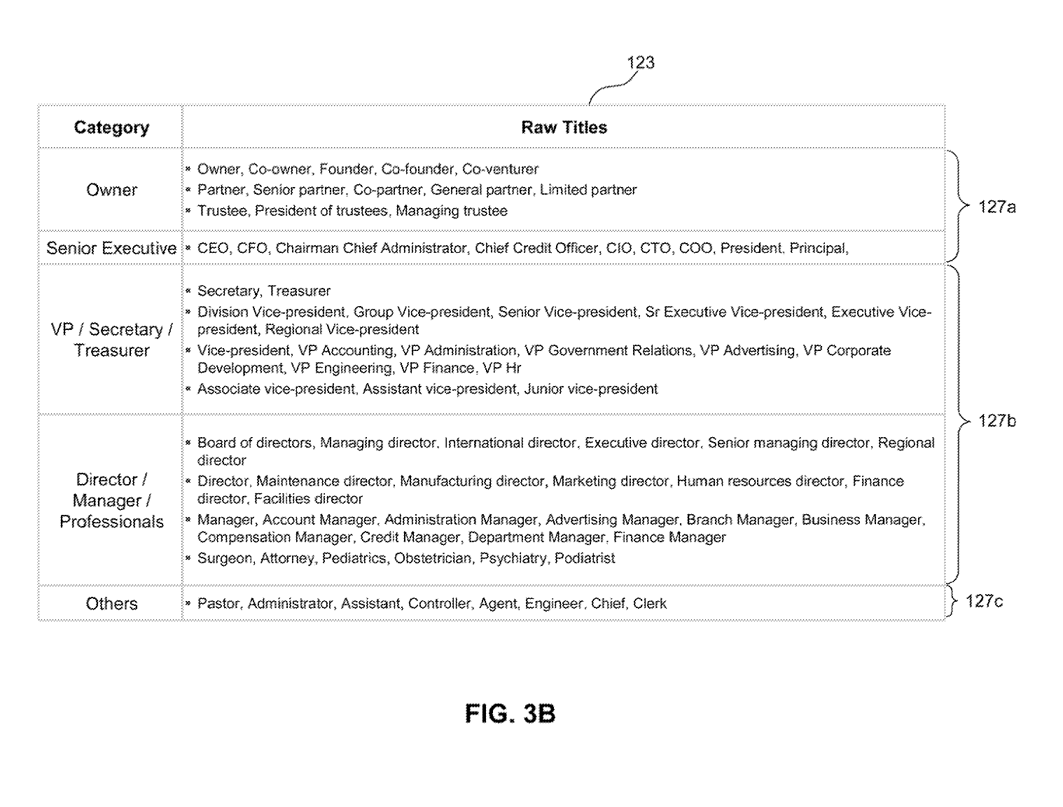

In accordance with an embodiment of the present invention, an authorized officer of a business is identified by determining authorized officers from the information on the business provided by an individual source vendor, and consolidating these source-level determinations of authorized officers to determine overall authorized officer(s) of the business with an associated measure of confidence. As used herein, an authorized officer is a member of a business entity who has been formally empowered by that entity to conduct business on its behalf. In one embodiment, an authorized officer is also formally empowered to enter into borrowing arrangements with financial institutions. Referring to FIG. 1, a flowchart is illustrating a process 100 for identifying an authorized officer, according to one embodiment of the present invention, as shown. At step 120 of process 100, information on one or more executives associated with a particular business is received from a plurality of data sources 110 (source 1, source 2 . . . source 5) and authorized officers are determined from each source's information, on a source by source basis. Data sources may be vendors such as Dunn & Bradstreet of Short Hills, N.J., Donnelley Marketing of Marshfield, Wis., Experian of Costa Mesa, Calif., Equifax of Atlanta, Ga., Mal Dunn Associates, Inc. of Brewster, N.Y., etc. The information on a particular executive provided by a source may include a raw title or designation of the executive. On a per source basis, the raw title is standardized at step 122 and classified at step 126 as being authorized (i.e., a title associated with an authorized officer) or non-authorized (i.e., a title not associated with an authorized officer). Further details concerning steps 122 and 126 of step 120 determination of authorized officers at the source-level, will be described below with reference to FIGS. 2 and 3. Thus, for each source, it is determined whether an executive identified by that source should be considered an authorized officer of the business, at the source-level.

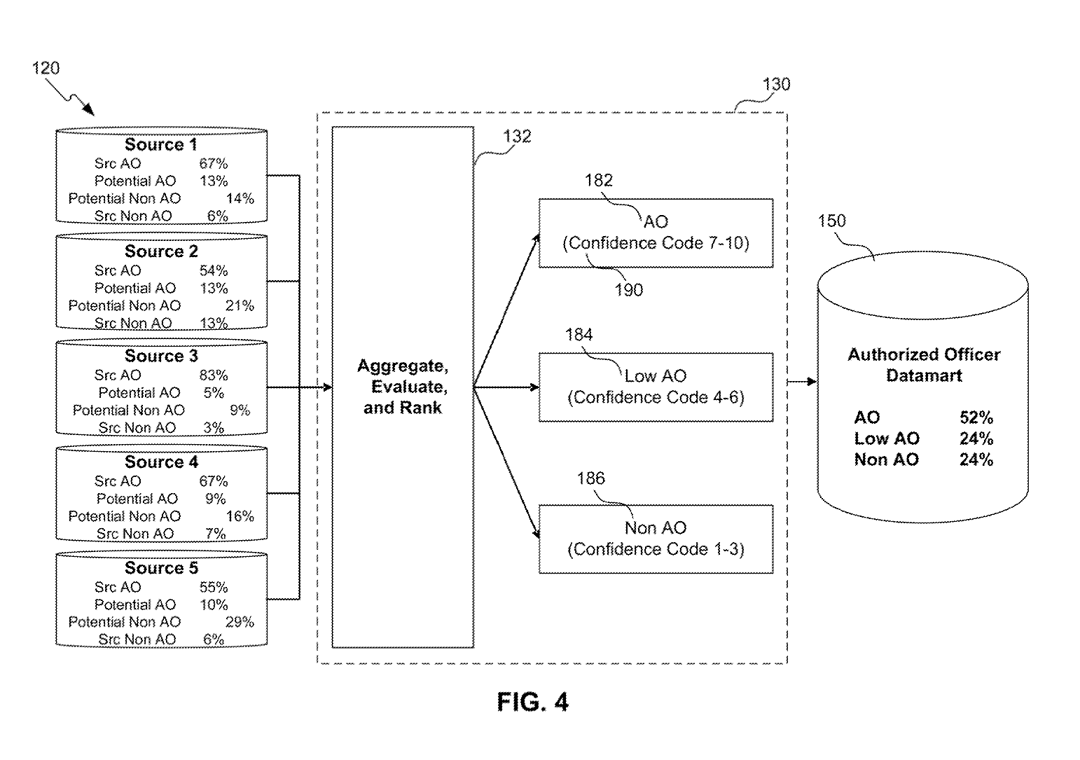

Referring to FIG. 1, information on the determined authorized officers at the source level are consolidated across the sources at step 130 to determine an overall authorized officer classification for each executive associated with the business. Thus, for a particular executive, the executive's title classification within each source is consolidated across the plurality of sources 110, and it is determined whether that executive has an overall classification as an authorized officer of the business. In consolidating across sources in step 130, conformance of each source's title classification of a particular executive is assessed. Based on this assessed performance, an overall AO classification is determined. Further details regarding assessing conformance and determining whether a particular executive should be classified as an authorized officer of the business are described below with reference to FIGS. 4 to 6.

Referring back to FIG. 1, once an overall authorized officer (AO) classification is determined for each executive associated with the business, this information is stored at step 140 in a database 150. In particular, identifying information of each executive is stored in database 150, along with that executive's overall AO classification 154 determined in step 130. In one embodiment, information stored on each executive may further include each standardized title 152 of the executive provided by the plurality of sources, and in another embodiment, the information may also include a conformance measure 156, or confidence code, indicating a degree at which the plurality of sources agreed with regard to their title classification for that executive.

Referring to FIG. 2, in step 122 each raw title or designation 123 of an executive provided by one of the plurality of sources 110 is standardized into a normalized title 124. FIG. 2 provides several representative examples of standardizing raw title 123 to normalize titles 124. For example, a raw title of “owner” may have an identical normalized title of “owner,” whereas a raw title of “partner” may have a normalized title of “owner.” Similarly, a raw title of “vice president” may have a normalized title of “VP,” and a raw title of “executive VP” may have a normalized title of “VP.” Standardizing raw titles in step 122 simplifies cross source comparison and consolidation in step 130, since the total number of different titles for executives are reduced when the title are normalized. For example, a particular source may have 550 different raw titles of executives within its information on businesses, which when standardized is reduced to only 216 normalized titles for these executives. Similarly, for example, a second source may provide 188 raw titles of executives associated with businesses, which when standardized is reduced to 117 normalized titles for these executives. Thus, comparison of standardized titles between the first vendor and the second vendor or the first source and second source is a comparison amongst the respective 216 normalized titles and 117 normalized titles, in contrast with the original 515 raw titles and 188 raw titles, respectively. One of skill in the art will recognize that any number of raw titles may be standardized to any number of normalized titles without departing from the spirit and scope of the present invention.

Further, in step 126, normalized titles are used for title classification. As shown in FIG. 3A, in step 126, each normalized title from each source in step 122 is first classified based on title alone (at sub-step 127), and then further classified based on “firmographics” (at sub-step 128). In sub-step 127, a normalized title is classified as an authorized officer (AO) title 127a, a non-AO title 127c or an undecided title 127b. In sub-step 128, undecided title 127b is separated into potential AO titles 128a, or potential non-AO titles 128b, thus distinguishing these further classified titles from those titles clearly classified as AO titles 127a and non-AO titles 127c. As used herein, “firmographics” refers to characteristics of a business that may provide some logical indicator of the extent of decision-making responsibility associated with job titles used by that business. For example and without limitation, firmographics may include a number of employees of a business, annual revenue, legal status, etc. Such information may be provided by the respective data sources. In the embodiment illustrated in FIG. 3A, the number of employees is used to further separate undecided titles 127b into potential AO titles 128a and potential non-AO titles 128b. As shown, the normalized title “VP” is an undecided title 127b. If this title of VP is associated with an executive of a business having greater than or equal to 50 employees, then such undecided title is further classified into a potential non-AO title 128b. In contrast, if the business has less than 50 employees, the same undecided title of VP may be classified as a potential AO title 128a. Thus, in this example, an underlying assumption of the classification rules is that the title VP likely carries decision making responsibility only in companies of less than 50 employees. Similarly, for a small business of less than 5 employees, regardless of the undecided title 127b (i.e., whether VP, treasurer, secretary, etc.), all such undecided titles 127b are classified as potential AO titles 128a, according to an embodiment. In contrast, for businesses with greater than 5 employees, all undecided titles other than a VP title are classified as potential non-AO titles 128b, according to an embodiment. In this way firmographics are used to further scrutinize whether a given job title with a particular company likely denotes decision making responsibility. As a result of step 126, a final authorized officer recommendation is made at each individual source level for each executive identified by that individual source.

FIG. 3B provides a table of representative raw designations (corresponding normalized titles not shown), of employees of a business and how such designations may be classified into AO titles 127a, undecided titles 127b, and non-AO titles 127c, in accordance with one embodiment of the present invention. In the chart of FIG. 3B, each raw title is associated with a job category based on the extent the title likely denotes decision making authority and the categories are ranked. For example, the category “Owner” has raw titles that most likely denote a job involving decision making authority, whereas the category “Others” has raw titles least likely denoting a job involving decision making authority. In the embodiment of FIG. 3B, AO titles 127a include those titles within categories “Owner” and “Senior Executive” , which are job titles typically associated with owners or senior executives of a business, whereas undecided titles 127b are titles within categories “VP/Secretary/Treasurer” and “Director/Manager/Professional”, which are job titles associated with junior executive positions of the business. Non-AO titles 127c are titles within the category of “Other”, which may be typical titles associated with all other employees of the business for non-executive positions.

As shown in FIG. 4, step 120 may be employed for each business for which a particular source has data. Executives may be classified into buckets of title classifications (e.g., AO, non-AO, potential AO, and potential non-AO titles) such that a distribution of title classifications of executives of businesses within each source can be obtained. Thus, for example, title classifications of executives of businesses for which Source 1 provides information is predominantly AO titles (at 67%). In comparison, Source 3's distribution of executive title classifications of businesses are predominantly AO titles (at 83%). Similarly, a distribution of title classifications of executives within Sources 2, 4 and 5 are obtained as a result of step 120, as illustrated in FIG. 4.

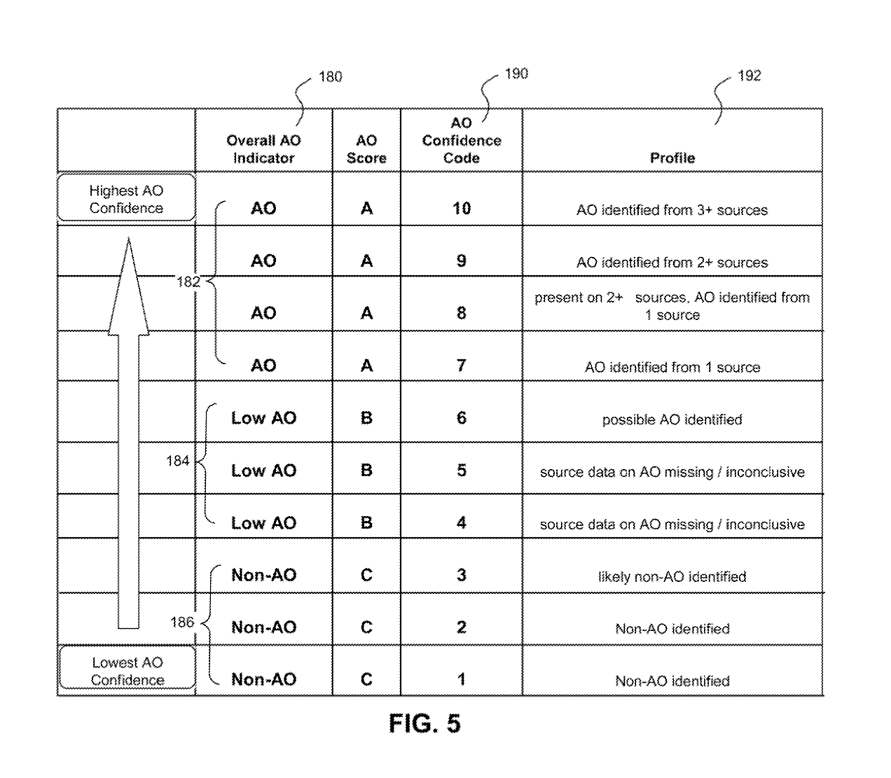

At step 130, for a particular business, the title classifications from each source (Sources 1 to 5) are merged together to derive a consolidated overall AO classification and measure of confidence (e.g., confidence code). This step includes step 132, in which, for each executive of a particular business, title classifications of the executive are aggregated across the sources, evaluated for conformity, and ranked. In the embodiment shown, the derived overall AO classification, or indicator, 180 (see FIG. 5) is one of an AO 182, a non-AO 186, or a low (or potential) AO 184. Each of these overall classifications 182, 184, and 186 is associated with a measure of confidence (or confidence code) 190. In this example, the higher the confidence code, the more likely an executive is classified as an AO 182, whereas the lower the confidence code, the less likelihood that the executive is classified as an AO. Referring to FIG. 4, the overall classifications of each executive, along with identifying information of executives (e.g., name, home and/or business address, etc.) and are then stored in database 150. In this example, database 150 is composed of just over half authorized officer classifications (at 52%), with the balance equally divided between low AO classifications 184 and non-AO classifications 186 (at 24%).

The information contained in database 150 may then be used to directly target executives with a desired overall classification that meets the needs of the soliciting institution. For example, a financial institution seeking to extend offers of financial transaction cards to businesses may desire to solicit only those executives having a classification of AO. In another embodiment, a financial institution or other institution may desire to solicit only those executives having an AO classification 182 that is associated with a confidence 190 that is above a given threshold value, thereby increasing the possibility that the solicitation reaches an executive of a business that can enter into a borrowing arrangement with the financial institution.

Referring to FIG. 5, an AO classification 182 may have an associated confidence code 190 ranging from, for example, 7-10, whereas a low AO classification 184 may have an associated confidence code 190 ranging from, for example, 4-6, and a non-AO classification 186 may have a confidence code ranging from, for example, 1-3. Thus, a soliciting institution may use the information stored in database 150 to filter out executives meeting a desired criteria of overall classification and associated confidence code. For example, a financial institution may wish to directly target an authorized officer of a business with a SB credit card offer. With the assessment that an executive is indeed an authorized officer, the financial institution is able to send a personalized, non-pre-approved offer mailed to the business, minimizing the risk of fraud. The financial institution may also confirm the creditworthiness of the executive, and send a pre-approved SB offer directly to the residence of the executive. In one embodiment, for example, the financial institution may decide to only send pre-approved offers to those executives whose overall classification 180 is an AO classification 182 and having a AO confidence code of 7 or above, so as to minimize the risk that such pre-approved offers may be received by non-authorized officers. For other executives with an AO classification, but with a confidence code of 6 or below, the financial institution may seek to suppress these executives from receiving SB credit card offers.

As shown in FIG. 5, each confidence code 190 may be mapped to a particular profile 192, which summarizes the extent of conformance across the plurality of data sources of an executive's title classification. Thus, for a confidence code of 10, and an overall classification of AO 182, the executive must be identified with an AO title by three or more sources. In comparison, an executive classified with an overall classification of AO 182, but with only a confidence code of 7, has a conformance profile 192 in which only a single source identified the executive with an AO title. In further comparison, low AO classifications 184 may have conformance profiles in which source data on the executive is missing or inconclusive, or in which the data source(s) classify an executive's title as only a potential AO title 128a, as described above with reference to step 128 of FIG. 3A.

Accordingly, the extent of conformance amongst inconclusive or missing AO data is reflected in the associated confidence code 190 for low AO classifications 184. Similarly, for non-AO classifications 186 and associated confidence codes, conformance profiles 192 are situations in which the plurality of sources conformed as to identifying the executive with a non-AO title classification. Accordingly, the highest conformance of non-AO classification receives an overall classification of non-AO 186 and the lowest confidence code 190 to indicate the least likelihood that such executives are authorized officers of a business.

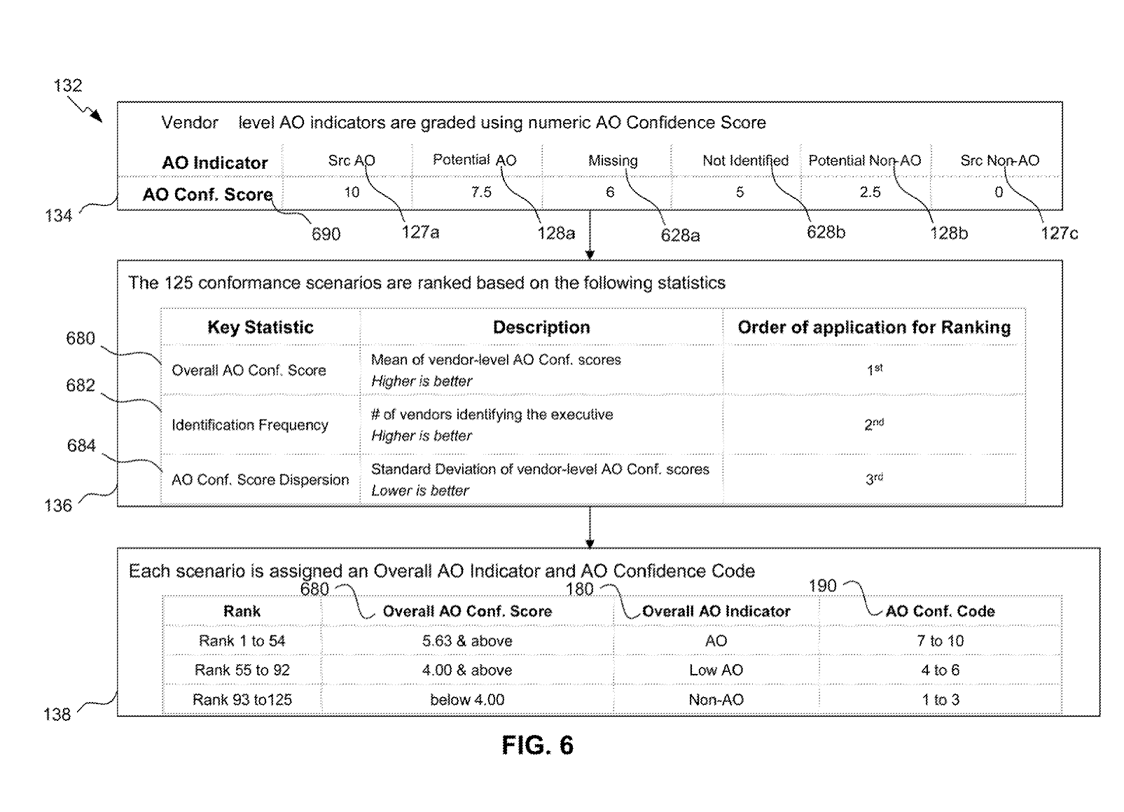

Further details regarding step 132 of step 130 will now be described with reference to FIG. 6. As noted above, in step 132, title classifications across the plurality of sources for each executive are aggregated and evaluated for conformance in order to derive an overall classification and associated confidence code. In the embodiment of FIG. 6, a statistically driven ranking approach is followed to collapse source level AO title classification to an overall classification and confidence code. In this embodiment, step 132 includes sub-steps 134, 136, and 138. In sub-step 134, source-level title classifications (or AO indicators) are graded using numeric confidence scores 690. By assigning a numerical identifier with each AO indicator, each conformance scenario may be statistically evaluated in sub-step 136, and the results may be ranked and mapped to overall AO indicators 180 and associated confidence codes 190 in sub-step 138.

Returning to sub-step 134, in this embodiment, AO indicators include not only title classifications of an AO title 127a, potential AO title 128a, potential non-AO title 128b and non-AO title 127c, described above with reference to FIG. 3A, but also an AO indicator of “missing” 628a and “not identified” 628b. The AO indicator of not identified 628b represents an instance in which, for a particular executive, a given data source does not have any information on the executive (i.e., the source does not identify the executive as being associated with the business). In comparison, the indicator of missing 628a indicates that the source identified the executive but did not associate the executive with a title. Each of these AO indicators are associated with a respective numeric confidence score 690. In this embodiment, confidence scores 690 range from 0-10, with the higher confidence score being associated with AO indicators representing possible AO titles (e.g., AO title 127a has a confidence score of 10 and potential AO title 128a has a confidence score of 7.5.

From these six different AO indicators, 125 conformance scenarios, or combinations, from the 5 source vendors may be evaluated and ranked based on one or more statistics 680, 682, and/or 684. In this embodiment, statistics 680 (an overall AO confidence score), 682 (identification frequency), and 684 (score dispersion) are applied in that respective order to achieve a ranking of each scenario in sub-step 138. Returning to sub-step 136, the overall AO confidence score 680 is obtained by taking an average of the source-level confidence scores 690 for a particular executive. Identification frequency 682 represents the frequency at which each executive is identified by the plurality of vendors, and AO confidence score dispersion 684 represents the standard deviation of source/level AO confidence scores 690.

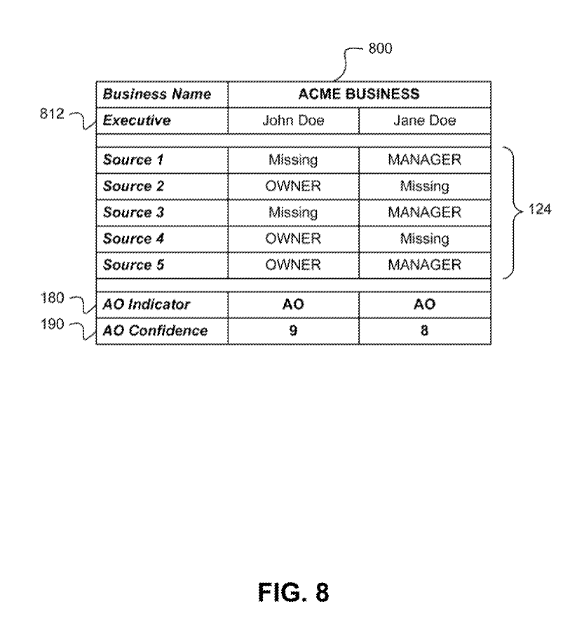

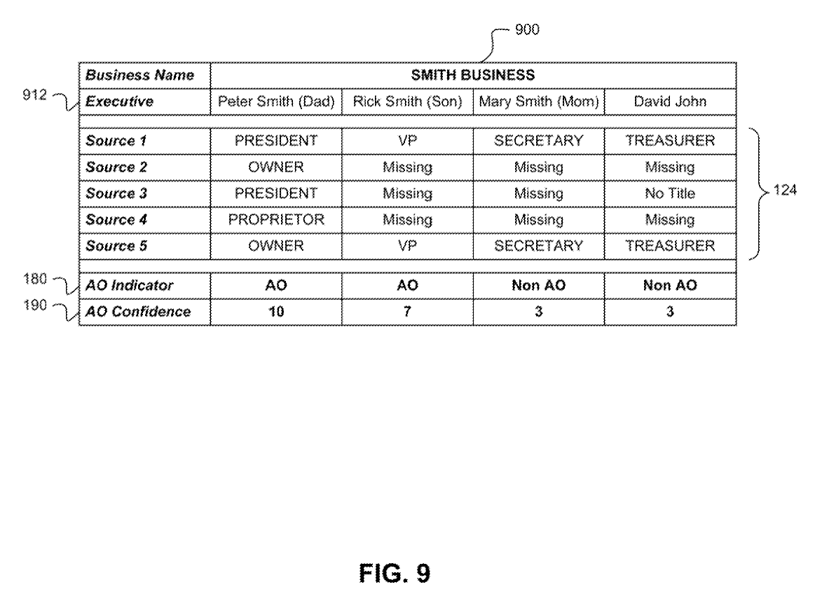

In exemplary sub-step 138, the statistical results are ranked and divided such that the lowest ranked performance scenarios (in this example, ranked 93 to 125) with an overall confidence AO confidence score 680 of below 4.0 are assigned an overall AO indicator 180 of non-AO with an associated confidence code ranging from 1-3. In comparison, executives with an overall confidence AO confidence score 680 of 5.63 or above are assigned an overall AO indicator 180 of AO with an associated confidence code ranging from 7-10, as described above with reference to FIG. 5. One of skill in the art will recognize that other scores and confidence score ranges may be used according to various embodiments. Examples of the application of process 100 to identify executives of two businesses will be described in further detail below with reference to FIGS. 8 and 9.

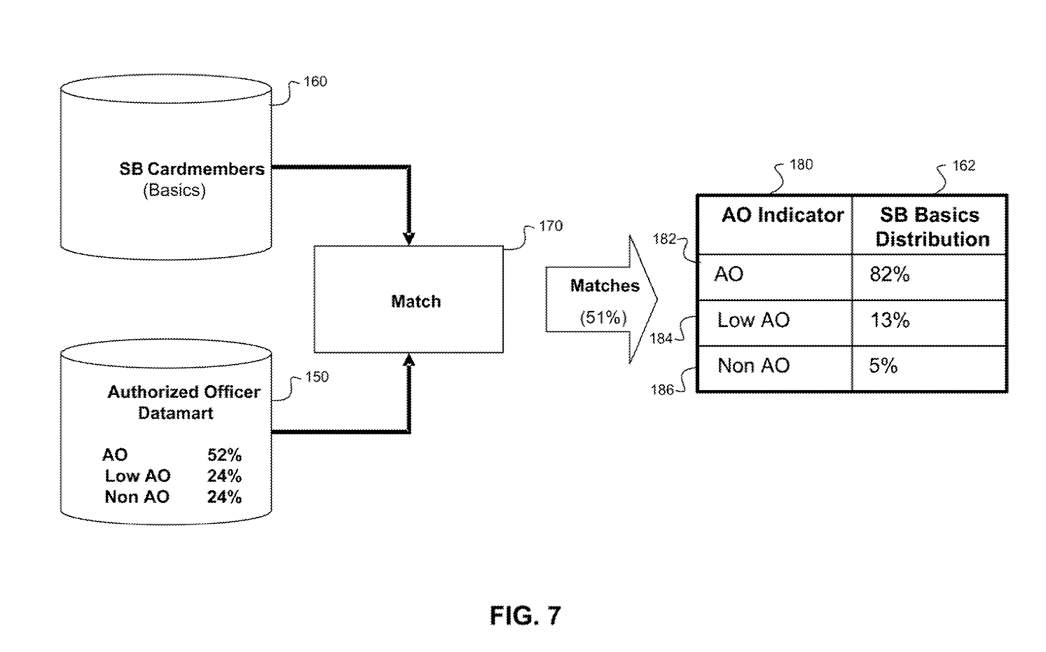

FIG. 7 illustrates a flow diagram showing an application of the information stored in database 150. In this embodiment, a financial institution wishing to assess whether its existing SB card members have an overall classification of AO may compare its database of card members with the information stored in database 150. As shown in FIG. 7, by matching at step 170 information on each executive stored in database 150 with information on SB card members stored in a database 160, an assessment of whether the SB card members are classified as authorized officers is achieved. In this example, the percent of matched executives is 51%, and of that percent, 82% are SB card members identified with an AO classification 182, 13% are identified with a low AO classification 184 and only 5% are identified with a non-AO classification 186. By determining whether an existing open card member is indeed an authorized officer of a business, the financial institution may then proceed to increase the card's credit line. In contrast, if an existing SB card member is not assessed to be an authorized officer of a business, the financial institution may choose to reduce the credit line of such SB card member, since that executive likely does not have authority to bind the company in the borrowing arrangement, and therefore the company may not be bound if credit funds taken are not repaid. In this manner, the financial institution is able to conduct risk management of its extended credit to businesses by increasing or decreasing the credit line based on the assessment of the cardholder's executive status within the business. Thus, in this example, the financial institution may choose to reduce the credit line of SB card members matched with a non-AO classification 186 and increase the credit line of SB card members matched with an AO classification of 182.

A similar matching process may be employed between card members that are individuals (i.e., not SB card members) and database 150, so as to identify those individual card members that may be in fact authorized officers of businesses, whereby the financial institution may cross-sell products and services to such card members in their role as business executives. For example, the financial institution, upon assessing that an existing card member is a likely authorized officer of a business, may add such card member to its prospect database for soliciting applications for an SB card membership. In another embodiment, process 100 may be used to identify authorized officers of merchants accepting the financial transaction cards of the financial institution, whereby the financial institution may add these authorized officers of the merchants to its prospect database in order to cross-sell SB card membership to visiting merchants. Thus, process 100 for identifying authorized officers of businesses may be used not only to solicit businesses with personalized offers and pre-approved offers, but also to cross-sell open financial cards to existing customers and merchants. In addition, the database 150 of identified authorized officers may be applied to the underwriting decision for SB card member applications. Prior to extending a line of credit, the financial institution may determine whether the applicant is identified as authorized officer in database 150.

Application of process 100 to example businesses to identify its authorized officer(s) will now be described with reference to FIGS. 8 and 9. In FIG. 8, a chart summarizes title classifications 124 for each Source 1-5 of each executive 812 of Acme Business 800 having 1-4 employees. In this example, executives 812 include John Doe and Jane Doe. Sources 2, 4, 5 have a title classification of owner for John Doe, whereas Sources 1 and 3 are missing a title classification for John Doe. Sources 1, 3 and 5 have a title classification of manager for Jane Doe, whereas Sources 2 and 4 are missing a title classification for Jane Doe in their records. In accordance with process 100, the conformance of title classifications across Sources 1-5 for each of John Doe and Jane Doe are assessed to derive an overall AO indicator 180, and associated confidence code 190. In this embodiment, John Doe and Jane Doe both have an overall classification of AO; however, since John Doe has a title by each Source 2, 4 and 5 of owner, which qualifies as an AO title 127a (see FIG. 3), John Doe has an AO confidence code of 9, higher than Jane Doe's confidence code of 8. Jane Doe's manager title is classified as an undecided title 127b and subjected to firmographic classification in step 128 of FIG. 3 to characterize the manager title as a potential AO 128a or a potential non-AO 128b. In this embodiment, Acme Business is a business of 1-4 employees, therefore Jane Doe's title of manager is classified as a potential AO title 128a, thereby providing Jane Doe an overall confidence score of 8.

Referring to FIG. 9, a chart of executive title classifications and overall authorized officer classification for Smith Business 900 having 10-19 employees is illustrated. Executives 912 of Smith Business 900 include Peter Smith, Rick Smith, Mary Smith, and David John. Each of Sources 1-5 supplies title classifications of Peter Smith of either president, owner, or proprietor. Each of these title classifications are classified as representing an authorized officer classification 127a, whereby the overall authorized officer classification for Peter Smith is an AO classification, with a maximum confidence code of 10, as all Sources 1-5 conform. Executives Mary Smith and David John, having titles of secretary and treasurer, respectively, have an overall AO classification of non-AO and confidence codes of 3. Executive Rick Smith has a VP title by only two sources and is missing a title classification by the other three sources, whereby executive Rick Smith has an overall classification of AO, but with only a confidence code of 7. In particular, since Rick Smith has a VP title in a business with less than 50 employees, then in accordance with the embodiment of FIG. 3, the VP title is initially an undecided title 127b that is then classified as a potential AO title 128a, in accordance with Smith Business's firmographics. As a result, Rick Smith has a lower confidence code 190 than Peter Smith, since Rick Smith's individual title classification at the source level is a potential AO 128a, and not AO 127a.

### II. Example Implementations

The present invention (i.e., process 100 or any part(s), function(s), or application(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

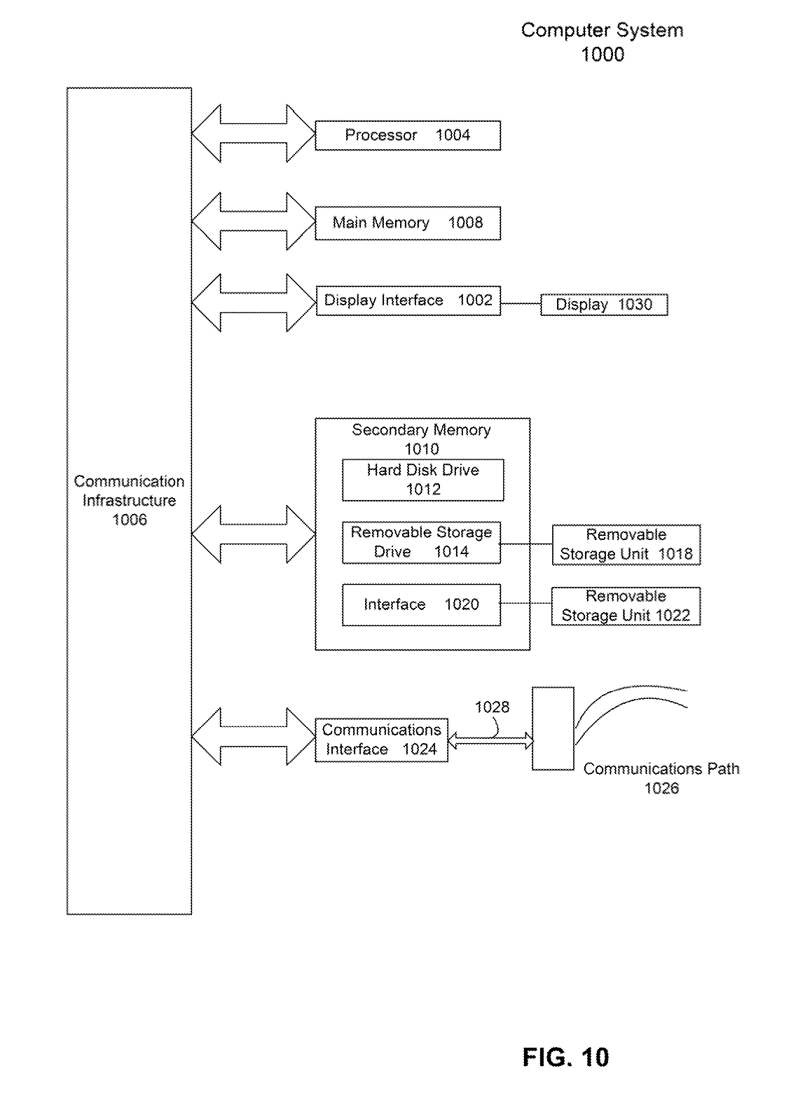

In fact, in one embodiment, the invention is directed toward one or more computer systems capable of carrying out the functionality described herein. An example of a computer system 1000 is shown in FIG. 10.

The computer system 1000 includes one or more processors, such as processor 1004. The processor 1004 is connected to a communication infrastructure 1006 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 1000 can include a display interface 1002 that forwards graphics, text, and other data from the communication infrastructure 1006 (or from a frame buffer not shown) for display on the display unit 1030.

Computer system 1000 also includes a main memory 1008, preferably random access memory (RAM), and may also include a secondary memory 1010. The secondary memory 1010 may include, for example, a hard disk drive 1012 and/or a removable storage drive 1014, representing a floppy disk drive, a magnetic tape drive, an optical disk drive, etc. The removable storage drive 1014 reads from and/or writes to a removable storage unit 1018 in a well known manner. Removable storage unit 1018 represents a floppy disk, magnetic tape, optical disk, etc. which is read by and written to by removable storage drive 1014. As will be appreciated, the removable storage unit 1018 includes a computer usable storage medium having stored therein computer software and/or data.

In alternative embodiments, secondary memory 1010 may include other similar devices for allowing computer programs or other instructions to be loaded into computer system 1000. Such devices may include, for example, a removable storage unit 1022 and an interface 1020. Examples of such may include a program cartridge and cartridge interface (such as that found in video game devices), a removable memory chip (such as an erasable programmable read only memory (EPROM), or programmable read only memory (PROM)) and associated socket, and other removable storage units 1022 and interfaces 1020, which allow software and data to be transferred from the removable storage unit 1022 to computer system 1000.

Computer system 1000 may also include a communications interface 1024. Communications interface 1024 allows software and data to be transferred between computer system 1000 and external devices. Examples of communications interface 1024 may include a modem, a network interface (such as an Ethernet card), a communications port, a Personal Computer Memory Card International Association (PCMCIA) slot and card, etc. Software and data transferred via communications interface 1024 are in the form of signals 1028 which may be electronic, electromagnetic, optical or other signals capable of being received by communications interface 1024. These signals 1028 are provided to communications interface 1024 via a communications path (e.g., channel) 1026. This channel 1026 carries signals 1028 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 1014, a hard disk installed in hard disk drive 1012, and signals 1028. These computer program products provide software to computer system 1000. The invention is directed to such computer program products.

Computer programs (also referred to as computer control logic) are stored in main memory 1008 and/or secondary memory 1010. Computer programs may also be received via communications interface 1024. Such computer programs, when executed, enable the computer system 1000 to perform the features of the present invention, as discussed herein. In particular, the computer programs, when executed, enable the processor 1004 to perform the features of the present invention. Accordingly, such computer programs represent controllers of the computer system 1000.

In an embodiment where the invention is implemented using software, the software may be stored in a computer program product and loaded into computer system 1000 using removable storage drive 1014, hard drive 1012 or communications interface 1024. The control logic (software), when executed by the processor 1004, causes the processor 1004 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A computer based method for identifying an authorized officer of a business, comprising:
(a) receiving, from a plurality of data sources, titles of executives associated with the business;
(b) classifying each executive's title as authorized or non-authorized;
(c) for each executive, assessing conformance across the data sources of the executive's title classification;
(d) classifying each executive as being an authorized officer, a non-authorized officer or a potential authorized officer based on the title classification and the assessed conformance;
(e) associating a measure of confidence with each executive classification;
(f) identifying as an authorized officer of the business each executive classified as an authorized officer with a measure of confidence that is above a predetermined threshold value; and
(g) storing in a database identifying information for identified authorized officers.

2. The method of claim 1, further comprising before the step of classifying each title as authorized or non-authorized:
normalizing the titles across the plurality of data sources.

3. The method of claim 2, wherein the step of classifying each title comprises:
classifying each executive's title as authorized officer, non-authorized officer or undecided; and
classifying any undecided title as authorized or non-authorized based on at least one of number of employees of the business and annual revenue of the business.

4. The method of claim 1, wherein each executive classified with an authorized title is identified as an authorized officer of the business.

5. The method of claim 1, further comprising:
offering a financial transaction instrument to at least one identified authorized officer of the business.

6. The method of claim 1, further comprising:
matching information on an authorized officer stored in the database with information on an applicant applying for a financial transaction instrument.

7. The method of claim 6, further comprising:
making an underwriting decision for the financial transaction instrument based on whether the applicant is matched as an authorized officer stored in the database.

8. A method for identifying an authorized officer of a business, comprising:
(a) receiving, from a plurality of data sources, information on at least one executive associated with the business;
(b) associating, for each data source, an authorized officer (AO) indicator for each executive;
(c) associating a measure of confidence with each AO indicator; and
(d) storing in a database identifying information of the executive, the executive's AO indicator and associated measure of confidence for each data source.

9. The method of claim 8, wherein, for each executive, the information from each of the plurality of data sources is one of a raw title of the executive, an absence of a raw title of the executive, or a missing identification of the executive, the method further comprising:
standardizing each raw title into a normalized title;
classifying each normalized title as AO, non-AO or undecided; and
classifying any undecided titles as potential AO or potential non-AO based on at least one of a number of employees of the business and annual revenue of the business, wherein the AO indicator of each executive for each data source indicates (i) the executive's title classification when the data source supplied a raw title of the executive, (ii) an absence of a raw title of the executive, or (iii) a missing identification of the executive.

10. The method of claim 8, further comprising:
for each executive, assessing conformance across the data sources of the executive's AO indicator using the associated measure of confidence for each AO indicator;
assigning an overall classification for each executive as being one of an overall AO title; an overall non-AO title, and a potential AO title based on the assessed conformance across the data sources;
associating a measure of confidence with the assigned overall classification for each executive based on the assessed conformance across the data sources;
determining as an authorized officer of the business each executive assigned with the overall AO classification with a measure of confidence that is above a predetermined threshold value; and
storing in the database identifying information of each executive, the executive's assigned overall classification and associated measure of confidence.

11. The method of claim 10, further comprising:
offering a financial transaction instrument to at least one of the determined authorized officers of the business.

12. The method of claim 10, further comprising:
matching information on each authorized officer stored in the database with information on an applicant applying for a financial transaction instrument.

13. The method of claim 12, further comprising:
making an underwriting decision for the financial transaction instrument based on whether the applicant is matched as an authorized officer stored in the database.

14. A computer program product comprising a computer usable medium having control logic stored therein for causing a computer to identify an authorized officer of a business, said control logic comprising:
first computer readable program code configured to cause the computer to receive, from a plurality of data sources, information on at least one executive associated with the business;
second computer readable program code configured to cause the computer to associate, for each data source, an authorized officer (AO) indicator for each executive;
third computer readable program code configured to cause the computer to associate a measure of confidence with each AO indicator;
fourth computer readable program code configured to cause the computer to, for each executive, assess conformance across the data sources of the executive's AO indicator using the associated measure of confidence for each AO indicator;
fifth computer readable program code configured to cause the computer to assign an overall classification for each executive as being either authorized or non-authorized based on the assessed conformance across the data sources;
sixth computer readable program code configured to cause the computer to associate a measure of confidence with the assigned overall classification for each executive based on the assessed conformance across the data sources;
seventh computer readable program code configured to cause the computer to determine as an authorized officer of the business each executive assigned with the overall classification of authorized and a measure of confidence that is above a predetermined threshold value; and
eighth computer readable program code configured to cause the computer to store in a database identifying information of each executive, the executive's assigned overall classification and associated measure of confidence.

15. The computer program product of claim 14, wherein, for each executive, the information from each of the plurality of data sources is one of a raw title of the executive, an absence of a raw title of the executive, or a missing identification of the executive, the computer program product further comprising:
ninth computer readable program code configured to cause the computer to standardize each raw title into a normalized title;
tenth computer readable program code configured to cause the computer to classify each normalized title as authorized, non-authorized or undecided; and
eleventh computer readable program code configured to cause the computer to classify any undecided titles as potential authorized or potential non-authorized based on at least one of a number of employees of the business and annual revenue of the business, wherein the AO indicator of each executive for each data source indicates (i) the executive's title classification, when the data source supplied a raw title of the executive, (ii) an absence of a raw title of the executive, or (iii) a missing identification of the executive.

16. The computer program product of claim 14, further comprising:
ninth computer readable program code configured to cause the computer to match information on an authorized officer stored in the database with information on an applicant applying for a financial transaction instrument.

17. A system for identifying an authorized officer of a business, comprising:
a data source database having information on at least one executive associated with the business received from each of a plurality of data sources;
one or more processors configured to associate, for each data source, an authorized officer (AO) indicator for each executive, to associate a measure of confidence with each AO indicator, to assess, for each executive, conformance across the data sources of each AO indicator using the associated measure of confidence for each AO indicator, to assign an overall classification for each executive as being either authorized or non-authorized based on the assessed conformance across the data sources, to associate a measure of confidence with the assigned overall classification for each executive based on the assessed conformance across the data sources, and to determine as an authorized officer of the business each executive assigned with the overall classification of authorized and a measure of confidence that is above a predetermined threshold value; and
a storage database having identifying information of each executive, the executive's assigned overall classification and associated measure of confidence.

18. The system of claim 17, wherein, for each executive, the information from each of the plurality of data sources in the data source database is one of a raw title of the executive, an absence of a raw title of the executive, or a missing identification of the executive,
wherein the one or more processors are further configured to standardize each raw title into a normalized title, to classify each normalized title as authorized, non-authorized or undecided, and to cause the system to classify any undecided titles as potential authorized or potential non-authorized based on at least one of a number of employees of the business and annual revenue of the business, wherein the AO indicator of each executive for each data source indicates (i) the executive's title classification, when the data source supplied a raw title of the executive, (ii) an absence of a raw title of the executive, or (iii) a missing identification of the executive.

19. The system of claim 17, further comprising an authorized officer processor to match information on an authorized officer stored in the storage database with information on an applicant applying for a financial transaction instrument.

20. The system of claim 19, wherein the authorized officer processor is further configured to make an underwriting decision for the financial transaction instrument based on whether the applicant is matched as an authorized officer stored in the database.
